(19) United States
(12) Patent Application Publication
(10) Pub. No.: US 2023/0399596 A1
(43) Pub. Date: Dec. 14, 2023

(54) TASTE IMPROVER FOR VODKA BEVERAGES

(71) Applicant: Jamie Stephen Henderson, Amherst, NH (US)

(72) Inventor: Jamie Stephen Henderson, Amherst, NH (US)

(21) Appl. No.: 18/208,703

(22) Filed: Jun. 12, 2023

Related U.S. Application Data
(60) Provisional application No. 63/351,304, filed on Jun. 10, 2022.

(51) Int. Cl. C12G 3/06; A23L 27/00

(52) U.S. Cl. CPC C12G 3/06; A23L 27/84

(57) ABSTRACT

A consumer additive for lower grade vodka to reduce harshness and bite, to replicate smoothness and flavor of top shelf vodka. The additive raises pH and adds trace minerals and sweetener to smooth out the flavor without adding a separate flavoring like fruit juice.

### BACKGROUND

Widely available, mass-produced vodka is cheap, both by being inexpensive and by being not very good. High-end vodka costs between 3 times and 10 times as much as low-grade vodka. However, the drinking experience for cheap vodka leaves much to be desired. This is often attributed to impurities which can mostly be removed with extensive filtration, but pure ethanol is also harsh and unpleasant to consume.

High-end European vodka generally has impurities. Some have trace sweeteners and many have trace minerals such as calcium carbonate, magnesium, sodium, potassium, nitrate, silica, bicarbonate, sulfate, etc., which may be added separately by the manufacturer or a deliberate carry-over of trace elements from processing or from the water used to make the vodka. The sweetener, in particular, will leave a sticky residue if the vodka is permitted to evaporate, while unsweetened vodka will not leave a sticky residue.

### SUMMARY

The purpose of this invention is to provide an additive a consumer may purchase separately and use to improve the flavor and experience of consuming low-end vodka. Although berry and citrus flavored additives are known, the inclusion of a fruit flavoring agent acts as a mask for the flavor of the vodka, and an unflavored additive used to improve the smoothness and general experience of consuming lower-grade vodka has not been known or available.

The additive includes one or more components to raise the pH of the vodka, one or more minerals to improve the flavor of the vodka without imparting a masking flavor, and a small amount of sweetener to reduce harshness and bite.

### DETAILED DESCRIPTION

In the following description, numerous specific details are set forth to clearly describe the embodiments disclosed herein. However, one skilled in the art will understand that some well known features have not been described in detail so as not to obscure the invention.

Both high-end and low-end vodka have approximately 40% ethanol and 60% water. Many of the trace minerals in high-end vodka are deliberately left in by the manufacturer, instead of being added separately. For example, calcium carbonate can be added via limestone filtration, and is therefore not considered a separate ingredient. Spring water can pick up trace minerals as it travels through the mountain, however, these minerals can be added separately as an ingredient.

The vodka additive includes means for buffering the pH of the vodka, at least one mineral that is in addition to the means for buffering the pH of the vodka, and means for reducing the burn of the vodka, such as trace sweeteners.

The means for buffering the pH of the vodka includes at least one of calcium bicarbonate, calcium carbonate, and an equivalent known chemical buffer suitable for dissolving in vodka for human consumption.

The at least one mineral in addition to the means for buffering the pH of the vodka includes at least one of magnesium, sodium, potassium, nitrate, silica, and sulfate.

The means for reducing the harshness of the vodka comprises a small amount of sweetener, such as sugar.

In the first embodiment, the invention comprises a non-powder solid, powder, or liquid packet formulated to raise the pH of cheap vodka using means for buffering the pH of the vodka, at least one mineral in addition to the means for buffering the pH of the vodka, and means for reducing the harshness of the vodka. This packet may be a size suitable for a single glass, or a size suitable to add to a bottle of standard size. The directions on the packet are simply to mix it with the vodka, and wait to consume until fully dissolved.

In the second embodiment, the invention comprises the packet of the first embodiment, combined with a filter. The directions on the packet include first filtering the vodka, and then adding the packet to the filtered vodka, followed by a short wait for the additive to be completely dissolved in the vodka prior to consumption.

While illustrative embodiments of the invention have been shown and described, variations and alternative embodiments will occur to those skilled in the art. Such variations and alternative embodiments can be made, such as the use of a single ingredient or two ingredients instead of all three, without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom. Packaging and sizes are in particular not intended to convey anything but the exemplary embodiment, and are not intended to limit the claims, and have explicitly not been included in the claims for that reason. Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for . . . ” and no method or process step herein is to be construed under the provisions of 35 U.S.C. section 112(f) unless the step, or steps, are expressly recited using the exact phrase “step(s) for . . . ”.

1. An additive packet for vodka, comprising at least two of:
means for buffering the pH of the vodka,
at least one mineral in addition to the means for buffering the pH of the vodka, and
means for reducing the harshness of the vodka.

2. The additive packet for vodka of claim 1, wherein when the additive packet for vodka includes at the at least one mineral in addition to the means for buffering the pH of the vodka, the at least one mineral in addition to the means for buffering the pH of the vodka includes at least one of magnesium, sodium, potassium, nitrate, silica, and sulfate.

3: The additive packet for vodka of claim 1, wherein the packet is accompanied by a filter for filtering the vodka before adding the contents of the packet to the vodka.

4: The additive packet for vodka of claim 1, wherein the additive is one of a liquid, a powder, and a non-powder solid.
